(19) United States
(12) Patent Application Publication
(10) Pub. No.: US 2014/0313472 A1
(43) Pub. Date: Oct. 23, 2014

(54) ASSEMBLY STRUCTURE FOR LENSES OF EYEGLASSES

(71) Applicant: SUN SIGHT GLASSES CO., LTD., TAINAN (TW)

(72) Inventor: JUI-CHI LI, TAINAN CITY (TW)

(73) Assignee: SUN SIGHT GLASSES CO., LTD., TAINAN (TW)

(21) Appl. No.: 13/866,153

(22) Filed: Apr. 19, 2013

(51) Int. Cl. G02C 1/06

(52) U.S. Cl. CPC G02C 1/06
USPC 351/86

(57) ABSTRACT

An assembly structure for lenses of eyeglasses is provided, in which the frame thereof mainly has two inlay grooves respectively provided at the inner edges of lens mounting apertures. The frame also has recessed portions provided at both outer ends of the lens mounting apertures for fitting snugly with positioning blocks. The positioning blocks has snap-fit portions provided at the upper end edges thereof. The snap-fit portions allow the positioning blocks to be fitted snugly in the recessed portions and to be locked firmly onto the frame, so that the lenses can be held securely within the lens mounting apertures by the positioning blocks. The design of the positioning blocks can match the overall design of the frame, thus there is no such case as to destroy aesthetics of the appearance of the frame, and the frame has more diversified designs. Moreover, the lenses can be processed in simpler way.

### BACKGROUND OF THE INVENTION

1. Field of the Invention

The present invention relates to an assembly structure for lenses of eyeglasses, particularly to novel one that does not destroy aesthetics of the appearance of frame, so that the frame has more diversified designs, and the lenses can be processed in simpler way, and more practical effect in its overall implementation can be enhanced.

2. Descriptions of Related Art

Generally, two mounting apertures are provided on the frame of eyeglasses for lens mounting. The outer side of each mounting aperture has a threading end for fixing by a screw. After the lenses are processed to match with the mounting apertures, the lenses are inserted into the mounting apertures and screws are threaded at the threading ends for fixing, so that the lenses can be held firmly within the mounting apertures without falling out. However, as screws have to be used for fixing the lenses in positions during the lenses mounting into the mounting apertures of the frame, not only much time has to be consumed but also a corresponding screwdriver is needed for threading. If a corresponding screwdriver is unavailable on hand, threading operation of the screws is impossible and thus lens mounting will becomes inconvenient.

In view of the above reason, a Taiwanese Patent Gazette No. M401787 entitled “Assembly Structure for Lenses of Eyeglasses” publicized on Apr. 11, 2011 was proposed by the inventor of the present invention, in which lens mounting apertures are provided on the frame of the eyeglasses, inserting grooves being provided in the inner edges of the lens mounting apertures and depression strips being pivotally provided on the lateral sides of the lens mounting apertures of the frame. One end of each depression strip is pivotally combined with the frame and the other end is formed with a fixing portion. A positioning projection corresponding to each depression strip is provided on the lateral side of each lens mounting aperture of the frame, and a fixing groove corresponding to the fixing portion of each depression strip is provided on the frame. The lenses are fixed into the inserting grooves of the lens mounting apertures, and positioning holes corresponding to the positioning projections on the frame are formed on the outer sides of the lenses.

The above “Assembly Structure for Lenses of Eyeglasses” can achieve expected effect of allowing the lenses assembly to become convenient, but is found in practical implementation that the positioning holes corresponding to the positioning projections on the frame have to be formed on the outer sides of the lenses, and this may cause difficulties in the lens processing. In addition, as the depression strips are pivotally provided at the lateral sides of the lens mounting apertures of the frame, the appearance design of the frame is limited by the depression strips. Not only the frame fails to have diversified design but also the aesthetics of frame's appearance is destroyed by the provision of the depression strips, and these may reduce product competitiveness. Thus, there are still rooms for improvement in its overall implementation.

In view of the above defects, the inventor of the present invention hereby proposes another assembly structure for lenses of eyeglasses according to the research and improvement conducted on the conventional product and based on his abundant experiences in both R&D and manufacturing of associated industries, so as to provide more choice of diversified structures for customers and to achieve better practical value.

### SUMMARY OF THE INVENTION

The main object of this invention is to provide an assembly structure for lenses of eyeglasses, in which the frame thereof has recessed portions provided at both outer ends of the lens mounting apertures for fitting snugly with positioning blocks. The design of the positioning blocks can match the overall design of the frame, thus there is no such case as to destroy aesthetics of the appearance of the frame, and the frame has more diversified designs. Moreover, the lenses can be processed in simpler way. Accordingly, it can increase more practical value in overall implementation thereof.

According to a preferred embodiment of the present invention, the assembly structure for lenses of eyeglasses mainly comprising a frame, positioning blocks and lenses, wherein:

the frame has two lens mounting apertures provided at both sides thereof, and two inlay grooves are respectively provided at the inner edges of the lens mounting apertures; the frame also has recessed portions provided at the outer ends of both the lens mounting apertures;

the positioning blocks are to be fitted in the recessed portions at both sides of the frame by the pivotal engagement between the positioning blocks and the recessed portions of the frame; the positioning blocks has snap-fit portions, which correspond to the upper ends of the recessed portions, provided at the upper end edges thereof, the snap-fit portions allowing the positioning blocks to be fitted snugly in the recessed portions and to be locked onto the frame;

the lenses correspond to the lens mounting apertures and are inserted and thus held into the inlay grooves on the rim of the lens mounting aperture by the positioning blocks.

According to a preferred embodiment of the present invention, the frame has pivots provided at both sides thereof to correspond to the recessed portions, and the positioning blocks have respective pivot holes, which correspond to the pivots of the recessed portions of the frame, provided at the bottom ends thereof, so that the positioning blocks can combine with the frame by the fitting of the pivot holes to the pivots of the recessed portions of the frame.

### BRIEF DESCRIPTION OF THE DRAWINGS

The present invention will be better understood by the detailed description of preferred embodiments with reference to the accompanied drawings, in which:

FIG. 1 is a perspective schematic exploded view of the present invention.

FIG. 2 is a perspective schematic view showing the assembly process of the present invention.

FIG. 3 is a perspective schematic view showing the appearance of the assembly of the present invention.

### DETAILED DESCRIPTION OF THE PREFERRED EMBODIMENTS

The technical contents, objects and effect of the present invention will become more apparent by the detailed description in conjunction with the accompanied drawings.

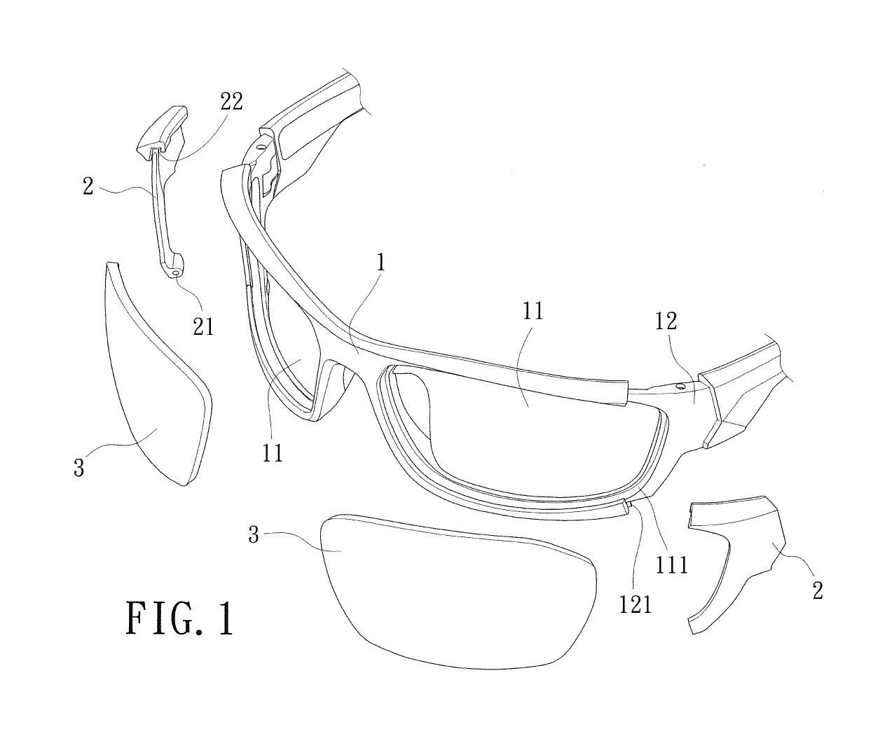

Firstly, FIG. 1 is a perspective schematic exploded view of the present invention. Referring to FIG. 1, the assembly structure for lenses of eyeglasses of the present invention comprises: a frame (1), positioning blocks (2) and lenses (3).

The frame (1) has two lens mounting apertures (11) provided at both sides, and two inlay grooves (111) are respectively provided at the inner edges of the lens mounting apertures (11). The frame (1) has recessed portions (12) provided at the outer ends of both lens mounting apertures (11). The frame (1) also has pivots (121) provided at both sides to correspond to the recessed portions (12).

The positioning blocks (2) are to be fitted in the recessed portions (12) at both sides of the frame (1). The positioning blocks (2) respectively have pivot holes (21), which correspond to the pivots (121) of the recessed portions (12) of the frame (1), provided at the bottom ends thereof, so that the positioning blocks (2) can combine with the frame (1) by the fitting of the pivot holes (21) to the pivots (121) of the recessed portions (12) of the frame (1). The positioning blocks (2) have snap-fit portions (22), corresponding to the upper ends of the recessed portions (12), provided at the upper end edge thereof. The snap-fit portions (22) allow the positioning blocks (2) to be fitted snugly in the recessed portions (12) and to be locked securely in the frame (1).

The lenses (3) correspond to the lens mounting apertures (11) and are to be inserted and thus held into the inlay groove (111) provided on the rim of the lens mounting aperture (11) by the positioning blocks (2).

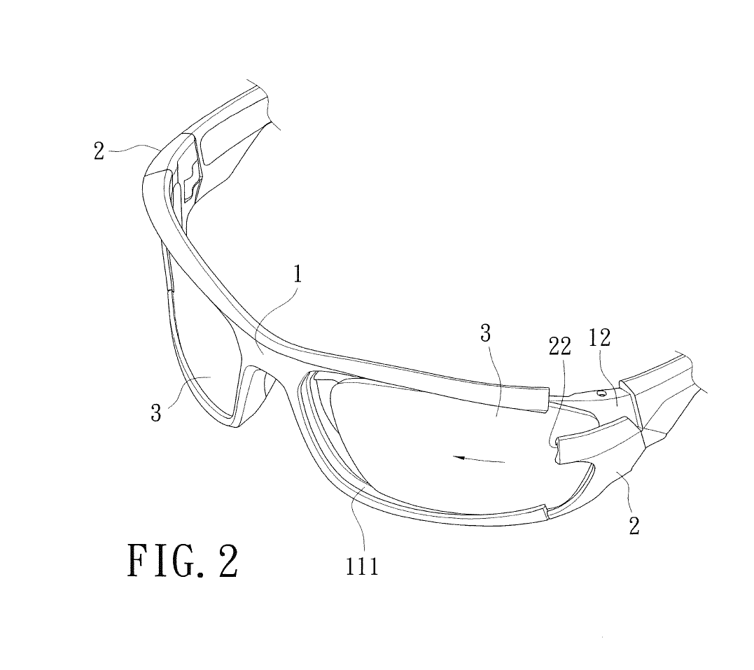

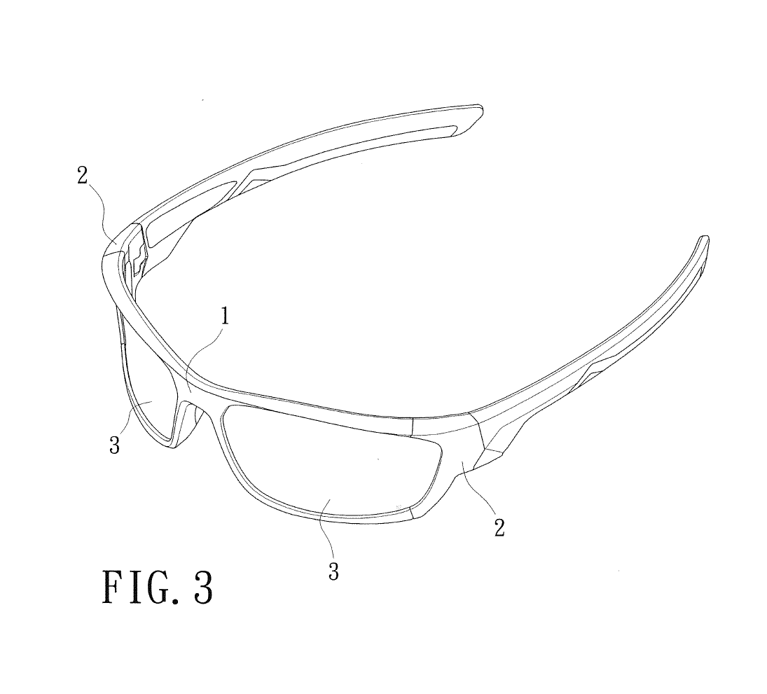

FIG. 2 is a perspective schematic view showing the assembly process of the present invention, and FIG. 3 is a perspective schematic view showing the appearance of the assembly of the present invention. In the assembling process as shown in these figures, the positioning blocks (2) are to combine with the frame (1) by the fitting of the pivot holes (21) on the bottom ends of the positioning blocks (2) to the pivots (121) of the recessed portions (12) of the frame (1) in such a manner that the positioning blocks (2) can be pulled out pivotally from the recessed portions (12) of the frame (1). Then, the lenses (3) can be inserted from the outside of the lens mounting apertures (11) into the inlay grooves (111) on the rims of the lens mounting apertures (11). In turn, the snap-fit portions (22) on the upper end edges of the positioning blocks (2) are locked firmly onto the frame (1). In this manner, the lenses (3) can be held securely within the lens mounting apertures (11) without coming off.

It is apparent from above description of the configuration and implementation of the present invention that this invention mainly has recessed portions provided at both outer ends of the lens mounting apertures of the frame for fitting with the positioning blocks, and the design of the positioning blocks can match the overall design of the frame. Therefore, there is no such case as to destroy aesthetics of the appearance of the frame, and the frame has more diversified designs. Moreover, as the lenses are held by the positioning blocks securely within the lens mounting apertures of the frame, the lenses can be processed in simpler way. Accordingly, it can increase more practical value in overall implementation thereof.

What is claimed is:

1. An assembly structure for lenses of eyeglasses, mainly comprising a frame, positioning blocks and lenses, wherein:
said frame has two lens mounting apertures provided at both sides, and two inlay grooves are respectively provided at the inner edges of said lens mounting apertures; said frame also has recessed portions provided at the outer ends of both said lens mounting apertures;
said positioning blocks are to be fitted snugly in said recessed portions at both sides of said frame by the pivotal engagement between said positioning blocks and said recessed portions of said frame; said positioning blocks has snap-fit portions, which correspond to the upper ends of said recessed portions, provided at the upper end edges thereof, said snap-fit portions allowing said positioning blocks to be fitted snugly in said recessed portions and to be locked securely onto said frame;
said lenses correspond to said lens mounting apertures and are to be inserted and thus held into said inlay grooves on the rim of said lens mounting aperture by said positioning blocks.

2. The assembly structure for lenses of eyeglasses as claimed in claim 1, wherein said frame has pivots provided at both sides thereof to correspond to said recessed portions, and said positioning blocks have respective pivot holes, which correspond to said pivots of said recessed portions of said frame, provided at the bottom ends thereof, so that said positioning blocks can combine with said frame by the fitting of the pivot holes to the pivots of said recessed portions of said frame.
